(19) United States
(12) Patent Application Publication
(10) Pub. No.: US 2005/0212417 A1
(43) Pub. Date: Sep. 29, 2005

(54) Display device with a thin-layered electroluminscent screen

(75) Inventor: Joel Fournier, Cergy Saint Christophe (FR)

Correspondence Address: FOLEY & LARDNER, 777 EAST WISCONSIN AVENUE, SUITE 3800, MILWAUKEE, WI, 53202-5308, US

(73) Assignee: Johnson Controls Automotive Electronics

(21) Appl. No.: 10/511,892

(22) PCT Filed: Apr. 18, 2003
(86) PCT No.: PCT/FR03/01259

§ 371 Date: May 26, 2005

(30) Foreign Application Priority Data
Apr. 19, 2002 (FR) 02/04929

(51) Int. Cl. H01J 1/62; H05B 33/12

(52) U.S. Cl. 313/506; 313/509

(57) ABSTRACT

The invention relates to a display device of the thin-film electroluminescent display type comprising a first layer (3) having an electroluminescent material between a second layer (2) forming the transparent front electrode and a third layer (5) having at least one first rear electrode (EL1). It is characterised in that said display comprises, behind the third layer (5), a fourth layer (7) having an electroluminescent material and a fifth layer (9) with at least one second rear electrode (EL2) masking an area which is not covered by the first electrode (EL1). Owing to the invention, information may be caused to appear in the illuminated background of a display device.

The present invention relates to the field of thin-flim electroluminescent displays. It targets in particular their application in automobiles where they are used to display information regarding the operation or state of the automobile.

An electroluminescent film is mainly composed of a stack of several layers between two transparent protective films, a layer formed from one or several front transparent electrodes, a dielectric layer, a layer comprising the electroluminescent material, a dielectric layer, a layer comprising one or several rear electrodes. The transparent electrode(s) are for example indium-tin oxide (ITO)-based electrodes. The electroluminescent layer is made from a semi-conductive phosphor material, the metallic electrodes may be aluminium and the protective films are made from a transparent flexible material.

When a sufficient electrical voltage is applied between two electrodes located in the front and rear layers, the electroluminescent material becomes an emitting material and a visible image is formed, the outline of which corresponds to that of the rear electrodes. The colour of the emitted light depends on the phosphor material which is used. One active element is thus created per electrode. Several individually controlled elements may be combined in order to display information on a dashboard of a vehicle for example.

These devices have certain advantages. In comparison with liquid crystal displays LCD for example, the thin-film luminescent displays are advantageous in that they offer a larger viewing angle, a more extensive display surface, they do not require additional illumination and they are thinner. This type of element is thus used in the background illumination of an automobile dashboard.

The image shown in FIG. 3 shows an example of a display which can be produced by this means. In this example of a digital display with three positions, each figure is formed from a set of 7 electroluminescent elements. These elements are individually controlled, as is known by the person skilled in the art.

Each element which is made live becomes luminous with respect to the background surface and is thus visible when it is in this state.

When a display of this type is used in the background illumination of all or part of the dashboard so as to illuminate the instruments, a problem arises when information is desired to be displayed by means of the same display. In fact, insofar as they are controlled and powered independently from one another, different elements are disposed so as to provide at least a small gap between the electrodes. This small gap must be at least 5/10 mm in order to avoid electrical problems. The small gaps which are located between the elements can be clearly seen in FIG. 3 in the form of short bars. It is not possible to bring them closer together. If a background illumination was desired to be combined with the display on single display screen then this small gap would pose a problem since a trace forming the outline of the luminous indicating element would remain. The presence of such a permanent trace would not be satisfactory from the point of view of the display clarity of the indicators and the visual comfort of the observer.

The aim of the Applicant is thus to find a solution to this problem.

In accordance with the invention, a display device of the thin-film electroluminescent display type comprising a first layer having an electroluminescent material between a second layer forming the transparent front electrode and a third layer having at least one first rear electrode is characterised in that said display comprises, behind the third layer, a fourth layer having an electroluminescent material and a fifth layer with at least one second rear electrode masking an area which is not covered by the first electrode. The second electrode in particular overlaps the edge of the first electrode.

Thus, in accordance with the invention, by placing two active elements of a display screen in different planes, the need to provide small gaps between the electrodes is obviated.

In accordance with another characteristic, the first electrode covers an area corresponding to a display background and has at least one hollow area, the second electrode masking at least part of the said hollow area. In accordance with a particular embodiment, since the first electrode has several hollow areas, the layer has second electrodes shaped so as to be complementary to the said hollow areas such that the first and second electrodes together mask all of the display background.

In accordance with another characteristic, the first and second electrodes are activated so as to display no information.

Generally, owing to the solution of the invention, an image can be caused to appear in all or part of a display device of which the background is illuminated by a thin-film electroluminescent display. The display elements are concealed in the foreground when they are not active. They are invisible to the naked eye when they are not requested. The background of the portion of the surface in question appears to be uniformly illuminated.

In an advantageous manner, the electroluminescent layers were formed from an electroluminescent ink and in particular the electrodes were also obtained by depositing conductive particles suspended in a liquid medium.

One embodiment of the invention will be described hereinafter with reference to the accompanying drawings, in which:

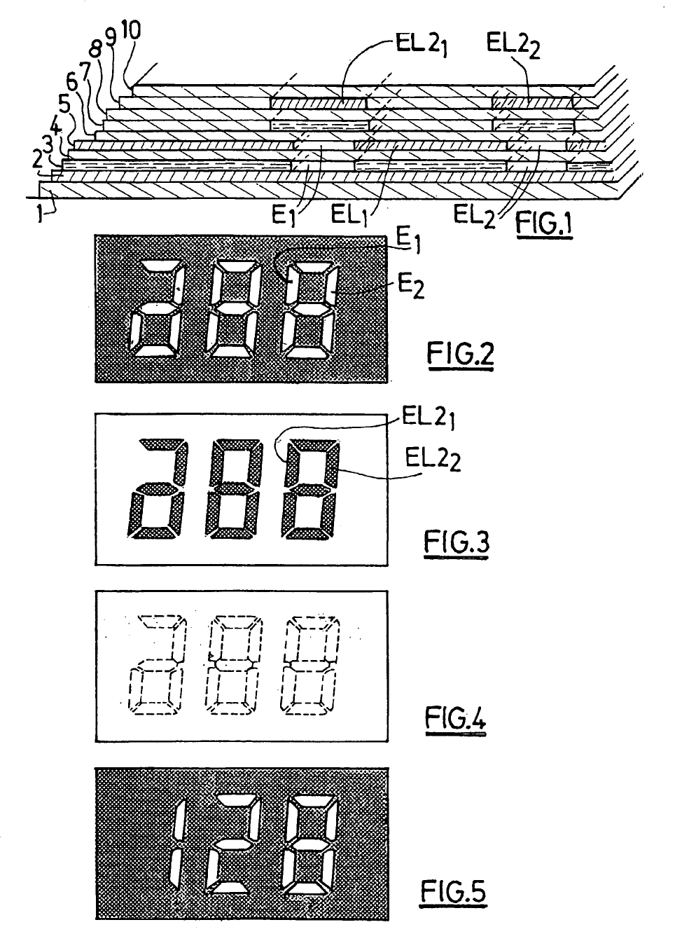

FIG. 1 is a schematic view of an electroluminescent display in accordance with the invention,

FIG. 2 is the image formed by the first electrode of the third layer,

FIG. 3 is the image formed by the second electrodes of the fourth layer,

FIG. 4 shows the superposition of the first and second electrodes,

FIG. 5 shows an image formed by the display.

FIG. 1 shows part of the electroluminescent display in accordance with the invention. It is formed by a plurality of layers 1 to 10. Generally, the different layers are applied by a screen printing process. The materials are suspended in a liquid medium in the style of an ink. The ink is applied on the surface in accordance with the stencil technique, wherein the areas which do not have to be inked are masked. After the liquid medium has been removed, a thin layer of a few microns, from 5 to 10, remains on the substrate with blank areas corresponding to the masked areas.

The transparent medium 1 is of a quality permitting printing by screen printing.

The common conductive layer 2, forming the front transparent electrode, is obtained by depositing indium-tin oxide (ITO) onto the transparent medium. The particles are suspended in a liquid medium by means of which they are then deposited onto their substrate.

Layer 3 is formed by depositing, by screen printing, a phosphor material which is in the form of an electroluminescent ink. The masks correspond to the areas which do not have any phosphor. In this example, the image of FIG. 2 is produced. The luminescent ink is applied over all of the surface except in spaces E₁ . . . Eₙ. These spaces are in the form of digits and are grouped in this example into three positions of a odometer. The three groups should display a number composed of three digits.

Layer 4 is made from a dielectric and transparent material. This material is applied in the form of a lacquer.

Layer 5 includes the first rear electrode EL1. This electrode continuously covers the surface of the display, except the spaces E₁ . . . Eₙ, the shape of which is shown in FIG. 2, thus as the electroluminescent layer. This conductive layer is advantageously applied by screen printing and the conductive material is ITO.

Layer 6 is a transparent dielectric made in the same manner as layer 4.

Layer 7 is formed by depositing a phosphor material in the form of an electroluminescent ink, in the same manner as layer 3. The applied pattern is that shown in FIG. 3. This pattern is the negative image of the pattern of FIG. 2. However, the digits are preferably slightly larger than the spaces of FIG. 2. FIG. 4 illustrates the manner in which the two patterns are superposed. Owing to the greater dimension of the segments of FIG. 3, the edges overlap.

Layer 8 is a transparent dielectric made in the same manner as the insulating layers 4 and 6.

Layer 9 comprises the second metallic electrodes EL2₁ . . . EL2ₙ. These are in the form of digits corresponding to those of the electroluminescent layer 7. Their arrangement is shown in FIG. 3. Each electrode is electrically controlled independently from the other electrodes.

Referring to FIG. 4, wherein the relative position which they occupy with respect to the first electrode and its spaces is shown, the electrodes EL2₁ . . . EL2ₙ are seem to completely mask the spaces E₁ . . . Eₙ. The dimension of the digits was chosen such that the active digits mask the spaces whilst overlapping the edges thereof. The outline of the active digits is shown in a dotted line.

Layer 10 is a transparent dielectric made in the same manner as the other insulating layers.

FIG. 5 illustrates an example of an image formed by the display. The image is the number 128. Since the background is completely illuminated, this image is obtained by switching off the appropriate digits. The observer, located in front of the display, sees the non-illuminated figures on an illuminated background.

Other arrangements are possible without departing from the scope of the invention.

In order to cause the figures to appear, the first electroluminescent layer (3) may not be illuminated and the digits of the second electroluminescent layer (7) which form the number may be illuminated. A “negative”-type display has thus turned into a “positive”-type display.

1. A display device of the thin-film electroluminescent display type, comprising:
a first layer having an electroluminescent material
a second layer forming a transparent front electrode
a third layer having at least one first rear electrode, the first layer being between the second layer and the third layer
a fourth layer behind the third layer and having an electroluminescent material; and
a fifth layer with at least one second rear electrode masking an area which is not covered by the first rear electrode.

2. The device as claimed in claim 1, wherein the second electrode overlaps an edge of the first electrode.

3. The device as claimed in claim 1, wherein the first electrode covers a surface corresponding to a display background and has at least one hollow area, the second electrode masking at least part of the said hollow area.

4. The device as claimed claim 3, wherein the first electrode has several hollow areas, and the fifth layer has second electrodes shaped so as to be complementary to the said hollow areas such that the first and second electrodes together mask all of the display background.

5. The device as claimed in claim 1, wherein the first and second electrodes may be activated so as to display no information.

6. The device as claimed in claim 1, wherein the electroluminescent layers are formed from an electroluminescent ink.

7. The device as claimed in claim 6,
wherein the electrodes are obtained by depositing conductive particles suspended in a liquid medium.

8. The device as claimed in claim 1, wherein the electoluminescent material of the first layer and the fourth layer can be controlled such that no areas are visible between portions of the electroluminescent material controllable to display information.

9. A display device comprising:
luminescent material;
electrodes configured to control illumination of the luminescent material such that the luminescent material can be controlled to display information;
wherein all of a display background can be controlled to be illuminated by luminescent material.

10. The display device of claim 9, wherein the luminescent material comprises,
a first layer comprising luminescent material; and
a second layer comprising luminescent material;
wherein the luminescent material of the first layer and the luminescent material of the second layer are separately controllable.

11. The display device of claim 10, wherein luminescent material is printed on the first layer.

12. The display device of claim 10, wherein the electrodes comprise
a first electrode associated with control of a section of luminescent material of the first layer;
a second electrode associated with control of the section of luminescent material of the first layer; and
a third electrode associated with control of a section of luminescent material of the second layer.

13. The display device of claim 12, wherein the first electrode is also associated with control of the section of luminescent material of the second layer.

14. The display device of claim 12, wherein
the second electrode is located in front of the first layer and the second layer;
the first electrode is located behind the first layer; and
the third electrode is located behind the second layer.

15. The display device of claim 14, wherein the third electrode overlaps the first electrode.

16. The display device of claim 10, wherein the first layer has a first set of areas that can be controlled to be illuminated, the second layer has a second set of areas that can be controlled to be illuminated, and the first set of areas and second set of areas are complimentary.

17. The display device of claim 9, wherein the luminescent material can be controlled such that no areas are visible between portions of the luminescent material controllable to display information.

18. A display device comprising:
luminescent material;
electrodes configured to control illumination of the luminescent material such that the luminescent material can be controlled to display information;
wherein the luminescent material can be controlled such that no areas are visible between portions of the luminescent material controllable to display information.

19. The display device of claim 18, further comprising a first layer having first luminescent material and a second layer having second luminescent material, wherein the first luminescent material may be controlled to be illuminated to display information and the second luminescent material may be controlled to be illuminated to mask spaces in the first luminescent material.

20. The display device of claim 18, wherein all of a display background can be controlled to be illuminated by luminescent material.

21. The display device of claim 18, further comprising,
a first layer having a first electrode,
a second layer, behind the first layer, having luminescent material,
a third layer, behind the second layer, having a second electrode,
a fourth layer, behind the third layer, having luminescent material, and
a fifth layer behind the fourth layer, having a third electrode.

22. A display device for use in an automobile, comprising:
a first electroluminescent active element located in a first plane; and
a second electroluminescent active element located in a second plane different than the first plane.
